(19) United States
(12) Patent Application Publication
(10) Pub. No.: US 2005/0077504 A1
(43) Pub. Date: Apr. 14, 2005

(54) Super Claw

(76) Inventor: Norberto Del Rio, Fort Lauderdale, FL (US)

Correspondence Address: Norberto Del Rio;Suite 122, 6451 N. Fed. Highway, Ft. Lauderdale, FL, 33308, US

(21) Appl. No.: 10/680,787

(22) Filed: Oct. 8, 2003

(51) Int. Cl. B66F 15/00

(52) U.S. Cl. 254/18

(57) ABSTRACT

A hollow frame houses the internal mechanism parts that is the air compression system, accommodates the claw & an additional screw on face, & also the air comfort hand grip. The air compression system consists of a piston attached to a bar with teeth which joins with the claw's teeth. The trigger is attached to the locking pin which locks the piston when in a cocked position. The head contains a thread for use with the additional face. The air comfort hand grip can be filled & emptied with air through the air comfort pump to accommodate the user's hand. The air compression system is secured at the back of the hammer with the seal bolt that also serves as the clasp for the additional face.

The [Super Claw] is a tool created for those people who use hammers and who would like the comfort and practicality of a hammer. The [Super Claw] reduces the use of manual labor, in extracting nails from a surface with force and in comfort at the same time.

### FIELD OF INVENTION

This invention relates to tools, specifically to an improved tool for the construction field.

### OBJECTS AND ADVANTAGES

Accordingly, several objects and advantages of my invention are:
[A] to provide a simple and practical way to extract nails from a surface.
[B] is unique because it requires no hoses or a compressor, it builds its own pressure
[C] it provides a simple was to reduce the amount of manual labor used opposed to a conventional hammer.
[D] it provides a pressure gauge so you will always know when it needs to be filled.
[E] is convenient because it can be filled at any air dispensing facility, [a gas station, auto mechanic shop, etc.] or your own air pump through the filling valve with a standard air chuck.
[F] it provides a comfortable use through the air comfort hand grip system, you can pump up the grip to preferred comfort control.
[G] it provides two different faces that can be used on the two main type of nails.

Further objects and advantages of my invention will become apparent from a consideration of the drawings and ensuing description.

### DRAWING FIGURES

FIG. 1 shows a full scale view

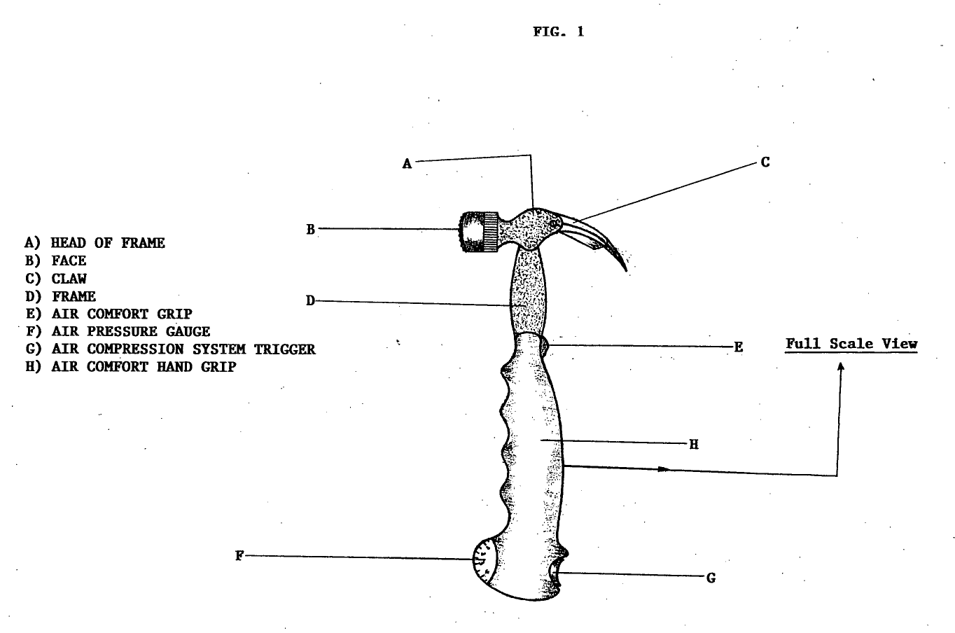

FIG. 2 shows an exploded view, a part by part

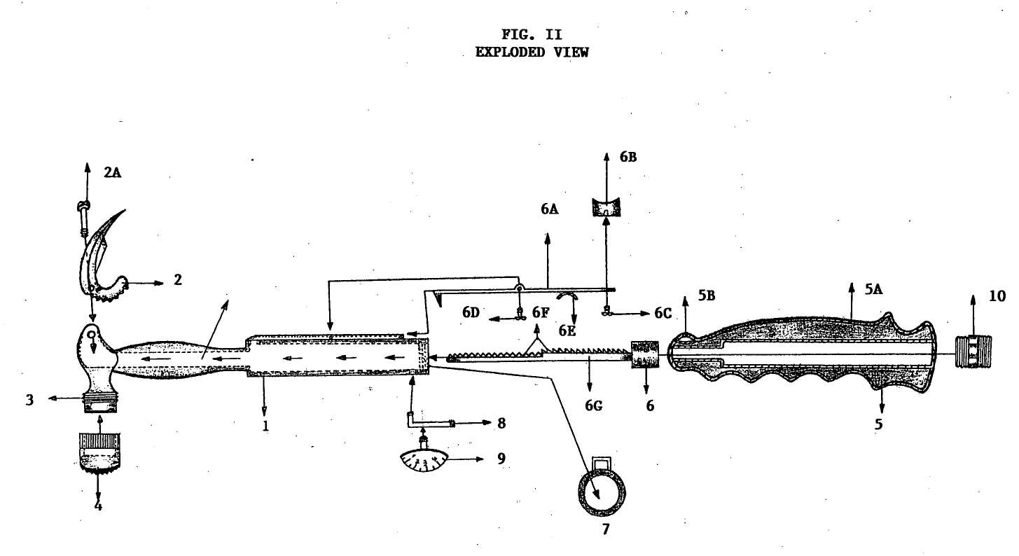

FIG. 3 shows a view of the [Super Claw] in a cocked (pos.1) and an uncocked (pos.2)

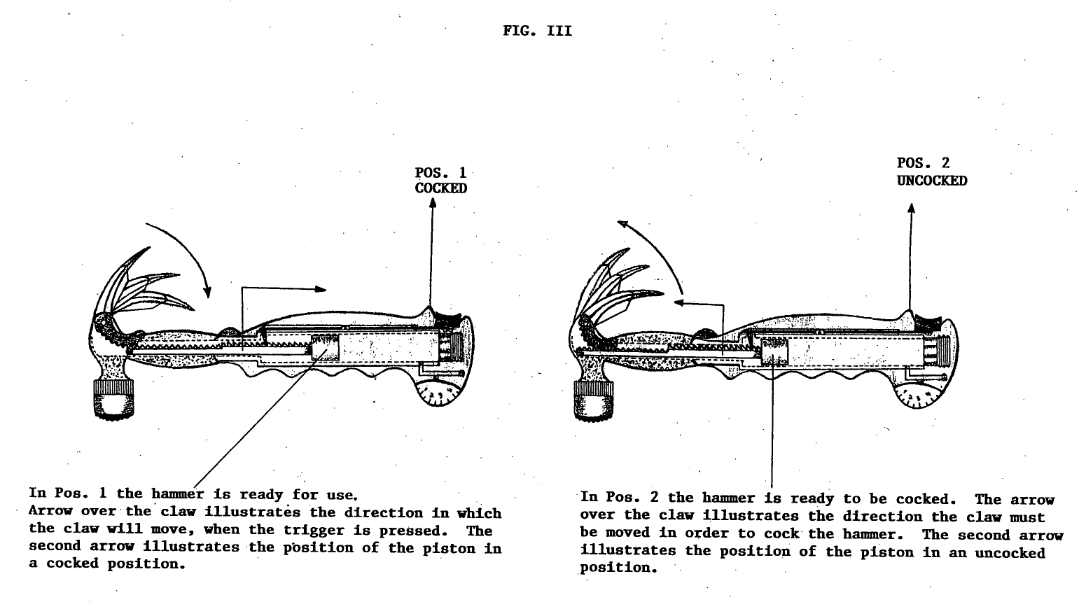

FIG. 4 shows a bottom view as well as a top view

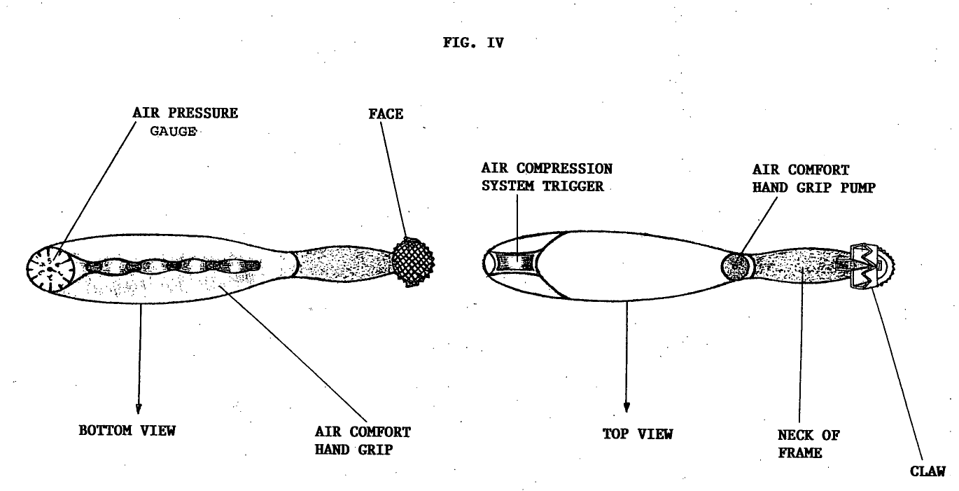

FIG. 5 shows a front view as well as a back view

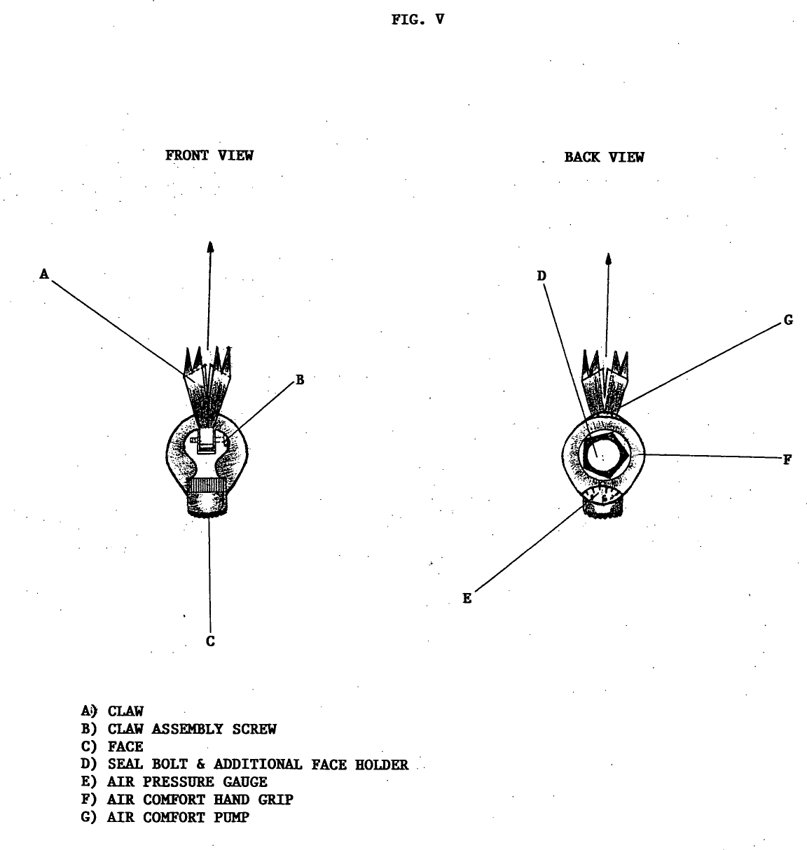

FIG. 6 shows an interior view of the frame.

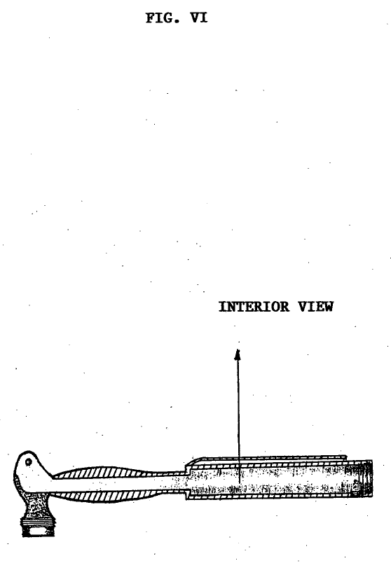

Reference numerals in drawings
1. Frame
2. claw
3. thread
4. addditional face
5. inner chamber hand grip
5A outer lining hand grip
5B hand grip pump
6. piston
6A locking pin
6B trigger
6C trigger assembly screw
6D locking pin assembly screw
6E spring action lever
6F teeth on bar
6G toothed bar
7. back opening view of frame
8. filling valve
9. pressure gauge
10. seal bolt

### DESCRIPTION

In numerical order I will explain the functions of each of the parts that integrates each one of the three major components of this invention.
1. The Frame: its only function is to serve as the housing of the major components of this invention.
2. The Claw: is an integral part of this invention, it has two functions. It serves as the cocking mechanism, and also extracting nails with pressurized force
2A. The assembly screw, its purpose is to fasten the claw to the head of the frame
3. The Thread: its only purpose is if need of the additional screw on face is required.
4. Additional Face: as stated in number 3 if required can be screwed to the head
5. The Air Comfort Hand Grip: accommodates to the user's grip
5A The outer lining composed of a rubbery material to prevent slippage while product is in use.
5B Air Comfort Pump: pumps air into inner cavity of hand grip to accommodate user with a firm grip of comfort.
6. The Piston: its function is the compression of air, by being attached to a bar of teeth which joins with the claws teeth
6A The Locking Pin: serves as a locking mechanism to keep the piston in place while in a cocked position.
6B The Trigger: releases the locking pin to set forth the pistons motion to the claw.
6C This assembly screw fastens the trigger to the locking pin.
6D This assembly screw fastens the locking pin to the frame
6E The spring Lever: it serves as a spring action lever to maintain the trigger in a up position whether the invention is in a cocked or a uncocked position.
6F The teeth of this bar attached to the piston serves as a gear in conjunction with the claws teeth to aid the piston in compression of air.
6G The bar is attached to the piston and is toothed as stated in number 6, letter F.
7. It is only a view to demonstrate that the frame is hollow.
8. The Valve: Its function is to aid in the filling of air of this product when pressure is low.
9. Pressure Gauge: serves as a dial to read where pressure levels are.
10. The Seal Bolt: seals the air compression system to prevent leaks and also serves as a housing for the additional face.

### OPERATION

Once the function of the different components are described it is easy to understand how they function together

The air is loaded through the filling valve (8, into the cavity of the frame. The pressure gauge (9, will read when its full. Now its ready to cock. To cock you move claw in direction as illustrated in [FIG. III, pos.2]. While moving the claw into a cocked position, the teeth on back side of claw act similar to a gear in conjunction with the toothed bar (6G, which moves pushing the piston (6, against the air, compressing it. All the while the locking pin (6A, rakes across the teeth till desired level of force is met. The locking pin locks the piston as illustrated in [FIG. III, pos.1]. The claw is placed under nail head to extract, when claw is in position. The trigger (6B, is pressed releasing the piston which in turn moves with compressed force, moving the claw which extracts the nail. The underside of the claw is equipped with a guard to prevent nail upon extracting due to the force to which the nail is extracted with, to become airborne, and cause harm to user or anyone else. Due to enclosed compressed air, moister is formed in cavity of frame, to clean and relieve of moisture, all need be done is remove seal bolt (10).

A. Air powered nail extraction tool, compromising:
a. a body consisting of a claw enabling the function of extraction of nails with pressurized force,
b. an air compression system within said body for producing said pressurized force, and
c. means for controllably coupling pressurized force from said system to said claw to extract nails from a surface.
